(19) United States
(12) Patent Application Publication
(10) Pub. No.: US 2015/0203142 A1
(43) Pub. Date: Jul. 23, 2015

(54) COLLAPSIBLE STRUCTURE FOR PREVENTING SEAT BACK OF BABY STROLLER FROM INCLINING FORWARD

(71) Applicant: PAO-HSIEN CHENG, TAINAN (TW)

(72) Inventor: PAO-HSIEN CHENG, TAINAN (TW)

(21) Appl. No.: 14/159,484

(22) Filed: Jan. 21, 2014

(51) Int. Cl. B62B 7/04

(52) U.S. Cl. CPC B62B 7/04

(57) ABSTRACT

A collapsible structure for preventing a seat back of a baby stroller from inclining forward is revealed. A mounting base for assembling with a seat back portion is disposed on a main frame at each side of the baby stroller. The seat back portion includes two base rods, an action block, and two crossed connecting rod sets arranged therebetween. One end of the base rod is disposed with a dent seat. Linkage members for stopping the seat back are disposed between the action block and the dent seat, and between the connecting rod set and the dent seat. Thereby the connecting rod sets are driven by the action block so that the dent seat is moved with the linkage members to be released from the mounting base. The base rod is against by the linkage members. Thus the folded seat back will not be inclined forward.

### BACKGROUND OF THE INVENTION

1. Fields of the Invention

The present invention relates to a collapsible structure for preventing a seat back of a baby stroller from inclining forward, especially to a collapsible structure for preventing a seat back of a baby stroller from inclining forward by means of movement and pulling force of linkage members while the seat back of the baby stroller being collapsed for storage.

2. Descriptions of Related Art

Generally, a stroller is a necessity for families with newborns. Babies are placed in the baby strollers so that parents can push the stroller easily to go around the block without holding the babies.

The baby stroller eases effort and saves time whenever taking a baby outside. For easy carriage, most of the baby stroller is collapsible for convenience of carriage. The collapsible baby stroller usually includes at least one locking mechanism, at least one unlocking mechanism, and a collapsible mechanism for operating the locking mechanism and the unlocking mechanism.

While not use, the main frames on two sides of the baby stroller are collapsed and close to each other by the foldable connecting rods. While pushing the main frames, a seat back of the baby stroller will be inclined forward a bit due to the connecting rods. Thus users need to press the seat back of the baby stroller backward during the process. However, users usually use both hands to fold the baby stroller for storage. Once the seat back is inclined forward, it's more difficult for the user to collapse the stroller for storage. Thus the design of the conventional seat back of the baby stroller has certain shortcomings.

Thus there is room for improvement and a need to provide a novel collapsible structure for preventing a seat back of a baby stroller from inclining.

### SUMMARY OF THE INVENTION

Therefore it is a primary object of the present invention to provide a collapsible structure for preventing a seat back of a baby stroller from inclining forward in which the seat back of the baby stroller is stopped by linkage members. Due to the dent seat moved together with the linkage members being pulled and backward pressing force, the seta back will not be inclined forward while being collapsed for storage.

In order to achieve the above object, a collapsible structure for preventing a seat back of a baby stroller from inclining forward of the present invention includes two mounting bases disposed on a main frame at each of two sides of the baby stroller respectively. The mounting base is used to be assembled with a seat back portion. The seat back portion consists of two base rods, an action block, two connecting rod set and two crossed connecting rod sets arranged between the action block and the base rods. One end of the base rod corresponding to the mounting base is disposed with a dent seat. Linkage members for stopping the seat back from inclining forward are not only disposed between the action block and the dent seat but also between the connecting rod set and the dent seat. Thereby the connecting rod sets are driven by the action block so that the dent seat is moved with the linkage members to be released from the mounting base. At the same time, the base rod is against and stopped by the linkage members. Thus the folded seat back will not be inclined forward during the collapsed process.

Moreover, a fixing pin used for positioning the two linkage members is arranged at the dent seat.

The dent seat is further disposed with an insertion part that is corresponding to the mounting base and the insertion part is mounted into the dent seat for stopping.

The linkage members are nylon pull strings.

The connecting rod set is composed of a first rod and a second rod pivoted to each other.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a perspective view of a seat back of an embodiment according to the present invention;

FIG. 3 is a perspective view of an extended seat back of an embodiment according to the present invention;

FIG. 4 is a perspective view of a collapsed seat back of an embodiment according to the present invention.

### DETAILED DESCRIPTION OF THE PREFERRED EMBODIMENT

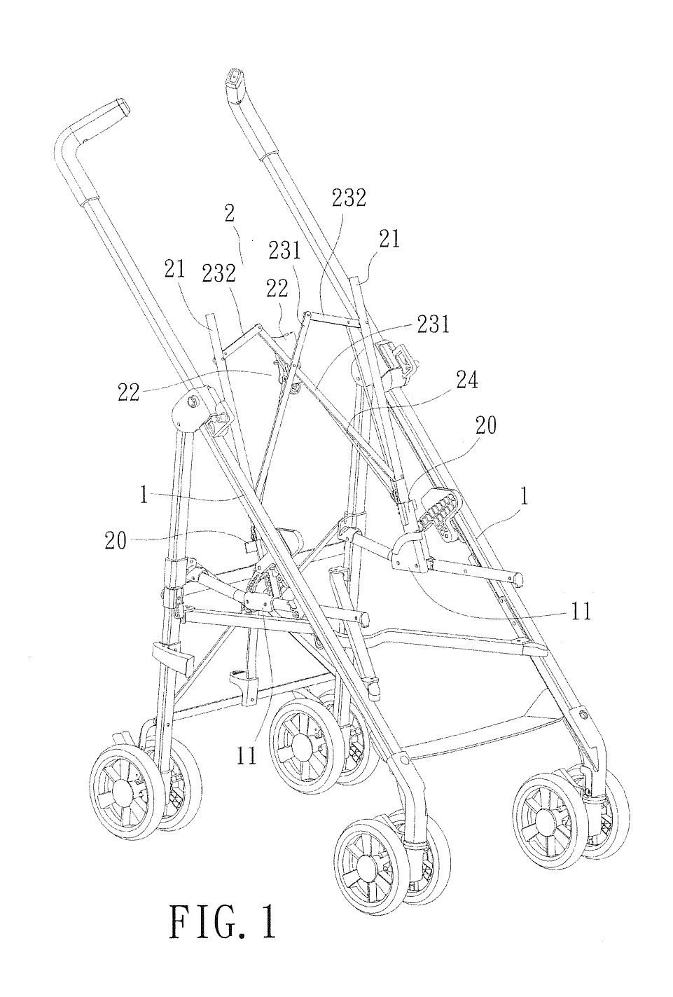

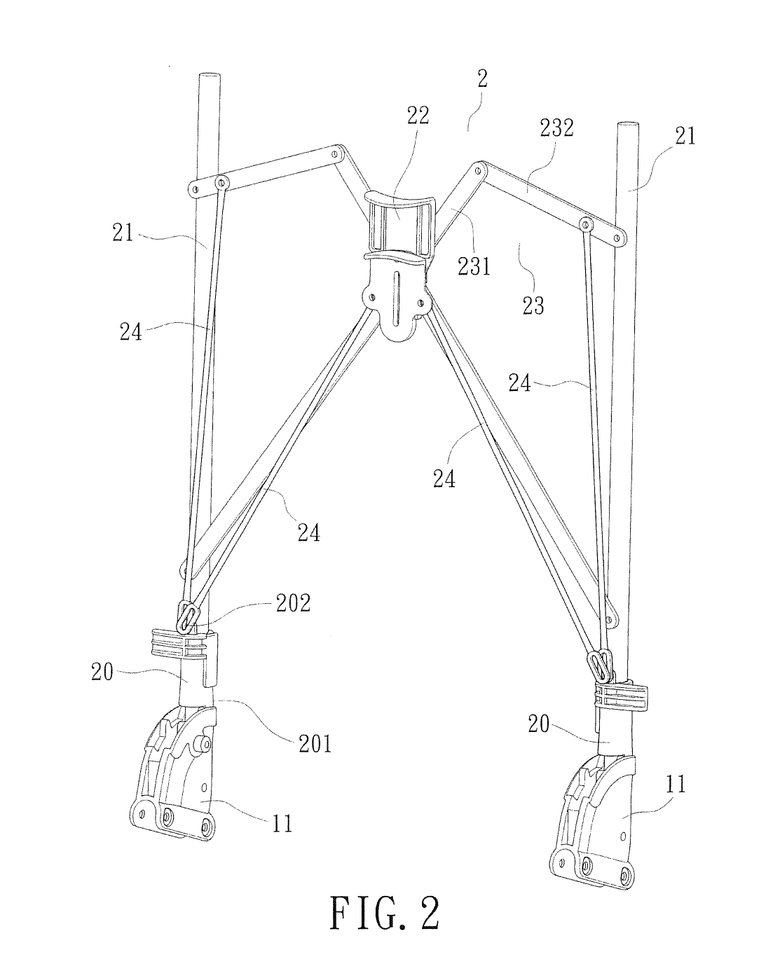

Refer to FIG. 1 and FIG. 2, a mounting base 11 is disposed on a main frame 1 at each of two sides of a baby stroller. The mounting base 11 is used to be connected to and assembled with a seat back portion 2. The seat back portion 2 includes dent seats 20, a set of base rods 21, an action block 22, two connecting rod set 23 and a plurality of linkage members 24. The set of base rods 21 include two base rods 21. The dent seat 20 corresponding to the mounting base 11 is enclosed around one end of the base rod 21. The dent seat 20 is assembled with the mounting base 11 and is for limiting and stopping the mounting base 11.

Each connecting rod set 23 consists of a first rod 231 and a second rod 232 pivoted to each other. The two connecting rod sets 23 are positioned on the action block 22 by the crossed first rods 231. The rear end of the first rod 231 and the rear end of the second rod 232 are pivoted to each base rod respectively.

The linkage members 24 are not only disposed between the action block 22 and the dent seat 20 but also arranged between the second rod 232 of the connecting rod set 23 and the dent seat 20. The linkage member 24 can be a nylon pull string.

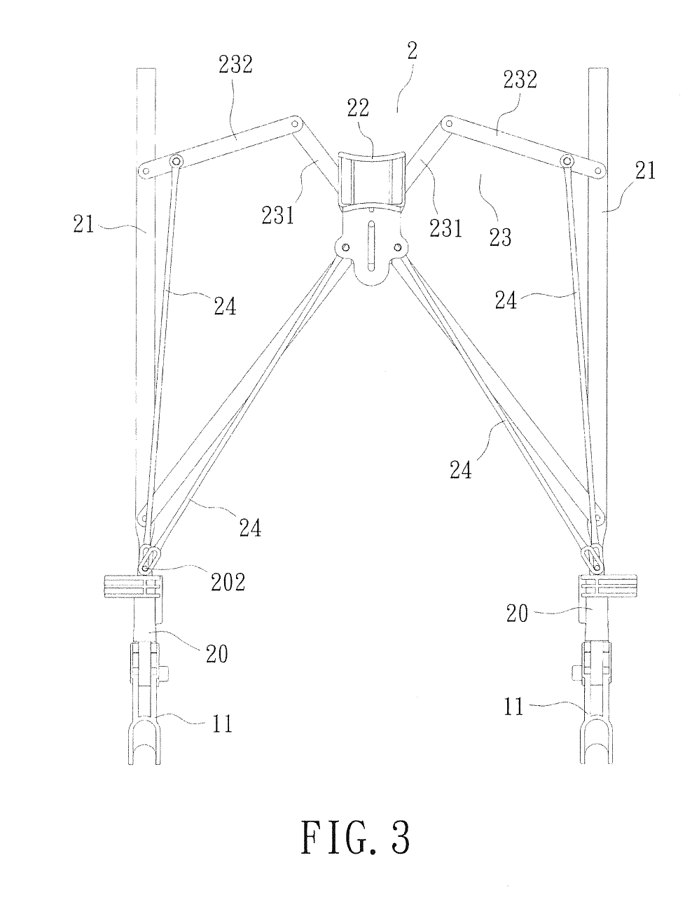

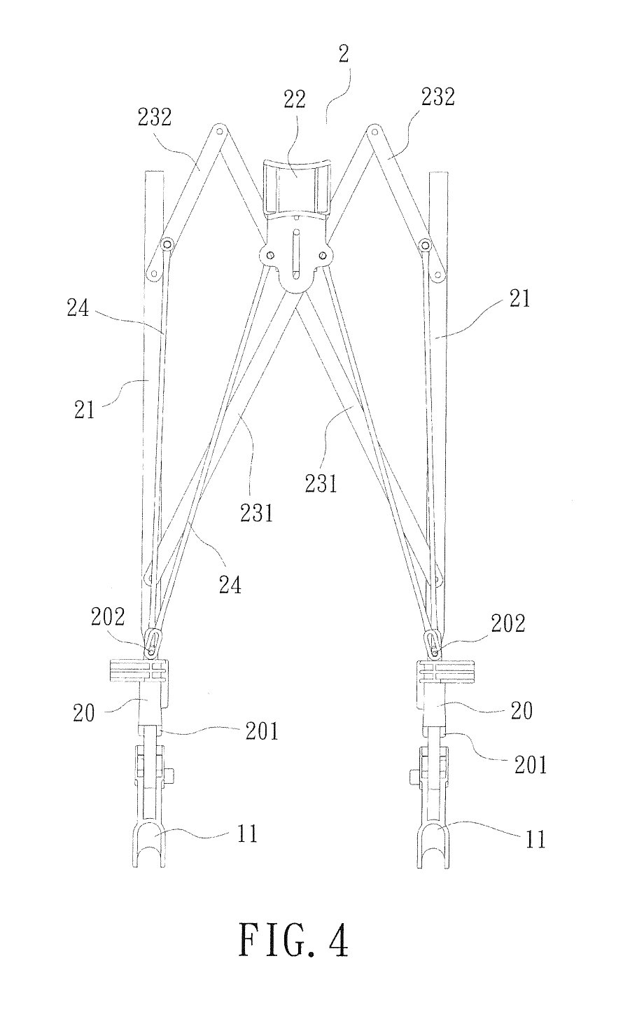

Refer from FIG. 1 to FIG. 4, while being assembled, the seat back portion 2 is arranged at the mounting base 11 on each of two sides of the main frame 1 of a baby stroller and each base rods 21 of the seat back portion 2 are mounted into the dent seat 20 correspondingly. The dent seat 20 includes an insertion part 201 corresponding to the mounting base 11 and the insertion part 201 is mounted into the dent seat 20 for stopping. The action block 22 between the two base rods 21 is assembled with the two connecting rod sets 23 so that the first rods 231 of the connecting rod sets 23 are crossed and positioned on the action block 22. One end of the first rod 231 is pivoted to a first position of the base rod 21 while the other end of the first rod 231 is pivoted to the second rod 232. The second rod 232 is pivoted to a second position of the base rod 21. When the action block 22 is moved, the two base rods 21 are driven by the two connecting rod sets 23 to be close to or away from each other. The linkage members 24 are not only disposed between the second rod 232 of the connecting rod set 23 and the dent seat 20 but also between the action block 22 and the dent seat 20. A fixing pin 202 used for positioning the linkage members 24 is arranged at the dent seat 20.

While the baby stroller is collapsed for storage, the action block 22 is pulled to move upward. Thus the first and the second rods 231, 232 of the connecting rod set 23 on each of two sides are also moved to make the two base rods 21 move close to each other. Due to the second rod 232 being moved upward, the dent seat 20 is also pulled to move upward by the linkage member 24 between the second rod 232 and the dent seat 20. Thus the insertion part 201 of the dent seat 20 is released from the mounting base 11. At the same time, the main frame 1 of the baby stroller is pressed to move backward by the two dent seats 20 and the seat back portion 2 will not be inclined forward.

Compared with the structure available now, the present invention has following advantages:
1. By the movement and pulling force of the linkage members, the seat back will not be inclined forward while being collapsed for storage.
2. Users can fold the baby stroller conveniently and fast due to the seat back that is not inclined forward while being folded.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A collapsible structure for preventing a seat back of a baby stroller from inclining forward comprising a mounting base arranged at a main frame on each of two sides of the baby stroller and a seat back disposed on the mounting base; wherein the seat back includes:
a set of base rods having two base rods and one end of the base rod corresponding to the mounting base is disposed with a dent seat; the dent seat is assembled with the mounting base for stopping the mounting base;
an action block;
two connecting rod sets each of which having a first rod and a second rod pivoted to each other; the two connecting rod sets are positioned on the action block by the crossed first rods; a rear end of the first rod and a rear end of the second rod are pivoted to the base rod respectively; and
a plurality of linkage members not only disposed between the action block and the dent seat but also arranged between the second rod of the connecting rod set and the dent seat.

2. The device as claimed in claim 1, wherein the dent seat is further disposed with an insertion part and the insertion part is corresponding to the mounting base; the insertion part is mounted into the dent seat for stopping.

3. The device as claimed in claim 1, wherein a fixing pin used for positioning the two linkage members is arranged at the dent seat.

4. The device as claimed in claim 2, wherein a fixing pin used for positioning the two linkage members is arranged at the dent seat.

5. The device as claimed in claim 3, wherein the linkage members are pull strings.

6. The device as claimed in claim 4, wherein the linkage members are pull strings.
